(19) United States
(12) Patent Application Publication
(10) Pub. No.: US 2021/0246068 A1
(43) Pub. Date: Aug. 12, 2021

(54) METHOD AND DEVICE FOR PROVIDING FLAT GLASS ELEMENTS WITH AN ANTI-CORROSION AGENT AND SEPARATION AGENT APPLICATION

(71) Applicant: Grafotec Spray Systems GmbH, Diedorf (DE)

(72) Inventors: Benjamin Maurer, Diedorf (DE); Sascha Rauh, Augsburg (DE); Reinhold Senft, Augsburg (DE)

(21) Appl. No.: 17/168,156

(22) Filed: Feb. 4, 2021

(30) Foreign Application Priority Data
Feb. 7, 2020 (DE) 10 2020 000 812.7

(51) Int. Cl. C03C 17/00; C03C 17/42

(52) U.S. Cl. CPC C03C 17/007; C03C 2218/17; C03C 2217/29; C03C 17/42

(57) ABSTRACT

When on flat glass elements an anti-corrosion agent and a separation agent, containing a powdery anti-corrosion agent and a powdery separation agent, is applied with the anti-corrosion agent and the separation agent being jointly applied on at least one side of the flat glass elements, the partial quantities of the powdery separation agent and the powdery anti-corrosion agent can be dosed according to requirement without causing an excess of separation agent or a shortage of anti-corrosion agent by holding ready and dosing the said anti-corrosion agent and separation agent independently from each other and by blending them together only after dosing.

### CROSS REFERENCE TO RELATED APPLICATIONS

This application claims priority to German patent application DE 10 2020 000 812.7, filed Feb. 7, 2020, the entire content of which is incorporated herein by reference.

### TECHNICAL FIELD

This disclosure relates to a method and device for providing flat glass elements with an anti-corrosion agent and separation agent application containing a powdery anti corrosion agent and a powdery separation agent, whereby the anti-corrosion agent and the separation agent are jointly applied on at least one side of the flat glass elements.

### BACKGROUND

At the end of the manufacturing process of flat glass it is usually stacked vertically. In order to avoid scratches on the flat glass elements and to facilitate a removal of the stacked elements at a later time, they are supplied before stacking on at least one side with a powdery separation agent. In order to prevent the stacked flat glass elements from corrosion in the form of becoming opaque, at least one side will be supplied with a powdery anti-corrosion agent. For forming the anti-corrosion agent and separation agent initially described, a combination powder exhibiting both properties has hitherto been used which is a blend of the powdery anti-corrosion agent with the powdery separation agent. Such a blend always exhibits a certain ratio of the individual constituents and has hitherto been offered only in a few firm blending ratios which suffice the average requirements. However, the case may arise that due to particular locations etc. a larger amount of anti-corrosion agent is required than in normal conditions. This circumstance can so far only be accounted for by increasing the supplied amount of combination powder with a defined blending ratio resulting in an increase of the partial quantity of both components which in the case of an increased requirement of anti-corrosion agent results in a corresponding increase of separation agent supplied, thus leading to an excess of separation agent. The waste of material resulting therefrom and the generation of costs is undesirable. In addition, the described excess of material may fall down when the flat glass elements are placed on the vertical stack, so that material may pile up in the region of the bottom edge of the stack leading to a wedge-shaped fanning of the flat glass elements stacked and thus to an increased space requirement which is likewise undesirable.

### SUMMARY

On these premises it is an object of the present disclosure to avoid the disadvantages as described above and to improve a method and device as initially described above in such a way that an increased requirement of one component of applied powder can individually be accounted for without simultaneously changing the amount of the other component applied.

The object is achieved by a method for providing flat glass elements and a device for carrying out the method. Accordingly, a method is proposed of providing flat glass elements with an anti-corrosion and separation agent application containing a powdery anti-corrosion agent and a powdery separation agent where the anti-corrosion agent and the separation agent are jointly applied on at least one side of the flat glass elements where the anti-corrosion agent and the separation agent are held ready independently from each other and dosed independently from each other and are blended together after dosing.

The solution of this task with regard to the device is specified herein. In particular, the device proposed accordingly comprises a dosing device, a container arrangement arranged upstream thereof, and further an application device arranged downstream thereof, with the container arrangement comprising a container associated with the anti-corrosion agent only suppliable with the powdery anti-corrosion agent and designed and arranged for the provision of the powdery anti-corrosion agent, and further comprising a container associated with the powdery separation agent only suppliable with the separation agent and designed and arranged for the provision of the separation agent, and with the dosing device comprising two dosers with an associated, separate doser being connected with the outlet of each container of the container arrangement, whose conveying quantity is adjustable independently from the conveying quantity of the other doser of the dosing arrangement and which is connected on the outlet with the application device. An equivalent variant may consist in that the doser is integrated in the application device thus simultaneously forming an element of the application device.

These measures ensure that for example in the case of an alteration of the amount of required anti-corrosion agent the respective partial quantity of the entire application can be changed correspondingly without the need to change the partial quantity of the entire application associated with the separation agent and vice versa. This ensures that neither an excess nor a shortage with regard to one component of the applied powder application is caused and correspondingly a waste of material as well as a disruption of stacking is avoided while reliably preventing damage to the flat glass elements. With these measures the above-described object is achieved in a most simple and low-cost manner.

Advantageous embodiments and expedient developments of the main-claim measures will be evident from the sub-claims.

Thus, an advantageous embodiment of the method according to the disclosure may consist in that the anti-corrosion agent and the separation agent are fed separately to the elements of the application devices adjacent to each other and simultaneously activatable, and are blended together only when applied to the flat glass elements. This ensures an evident and clear method implementation.

An alternative may consist in that the anti-corrosion agent and the separation agent are merged after dosage and are subsequently applied as a powder mixture to the flat glass elements by means of a common element of the application device. In this manner, the design of the application device is facilitated and its space requirement reduced.

An advantageous development of the device according to the disclosure may consist in that each doser issues in an associated injector which is suppliable with an air jet and connected with a flow line leading to the application device. This results in a reliable flow transport of the material released by the dosers, so that it can be sprayed on the flat glass elements.

A further advantageous embodiment may consist in that the application device comprises at least one application beam arranged transversely to the direction of feed of the flat glass elements transportable below the said application device comprising several application nozzles distributed along its length, with each application beam being connected with a distributor arranged downstream of the dosing device, which comprises several outlets connected with the application nozzles of the associated application beam and further comprises an inlet which is connected with at least one flow line branching off the dosing device. It is thus ensured that even comparatively broad flat glass can be evenly supplied in the spraying process.

A first variant may consist in that the application device comprises two mutually adjacent application beams and that for each application beam an associated distributor is provided whose inlet is connected with a branchless flow line suppliable from one associated container only of the container arrangement. Since in this case provision is made for a separate application beam for each component of the powder application, a comparatively large amount can be sprayed per time unit, so that the flat glass elements can be transported at a comparatively high speed while a sufficient partial quantity of each component can be sprayed on.

Another embodiment may consist in that the application beam comprises only one application beam and that the distributor associated therewith is connected on the inlet side with a collection connecting piece in which issue the flow lines suppliable from both containers of the container arrangement. Since only one nozzle beam is required, the design is comparatively simple and space saving.

Further advantageous embodiments and expedient developments of the main-claim measures will be evident from the remaining sub-claims and from the description of an example given below in conjunction with the accompanying drawings.

### BRIEF DESCRIPTION OF THE DRAWINGS

The disclosure will now be described with reference to the drawings wherein:

FIG. 1 shows a schematic view of a first embodiment of a device according to the disclosure for supplying flat glass elements with an anti-corrosion agent and a separation agent with two application beams; and

FIG. 2 shows a variant of FIG. 1 with only one application beam.

### DESCRIPTION OF EXEMPLARY EMBODIMENTS

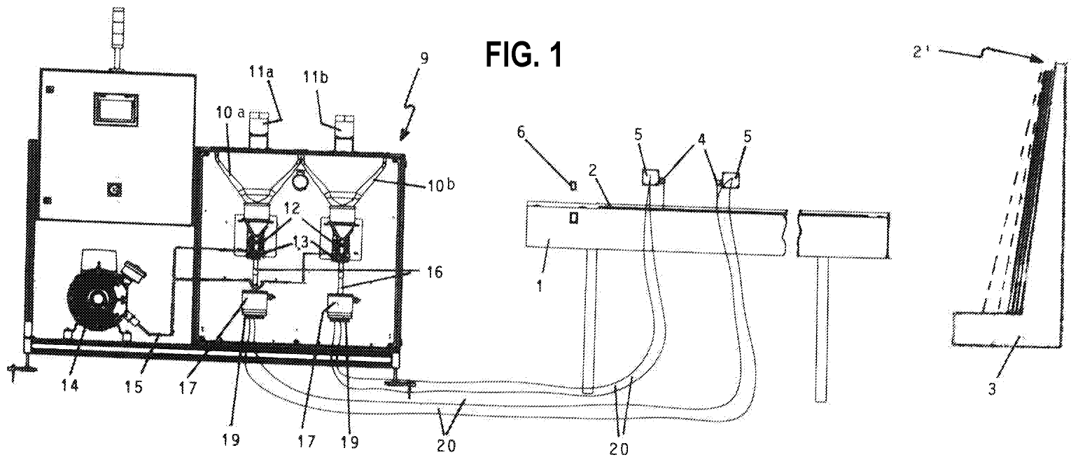

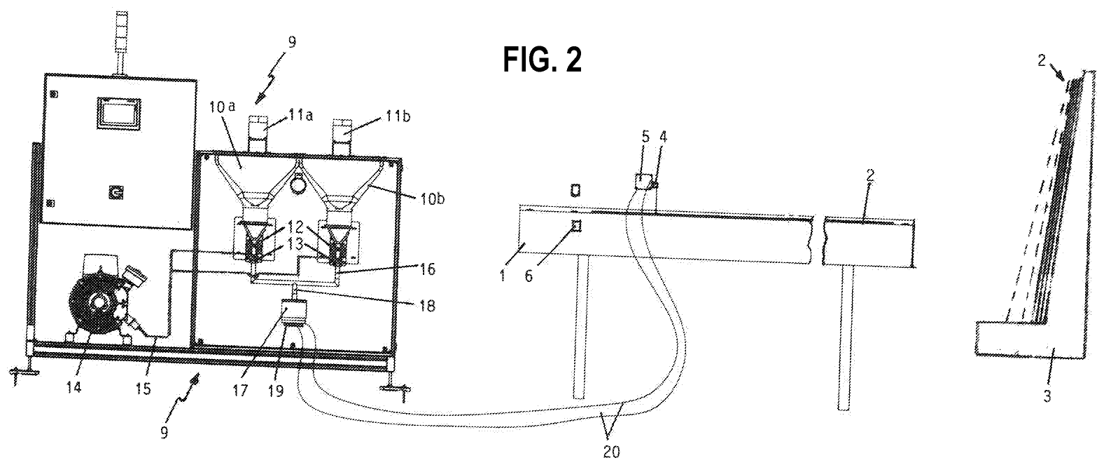

In FIGS. 1 and 2, a transport line is indicated which may be arranged on the exit of a production line, not shown in detail, for producing flat glass elements to be used as window glass, for example. The flat glass elements 2 are transported to a stack rack 3 via the transport line 1 on which stack rack 3 a vertical stack 2′ formed by flat glass elements leaning on each other is receivable. For the formation of the stack a suitable handling device or a programmable robot may be provided. Prior to the formation of the stack the powder is applied on at least one side of the flat glass elements, such powder comprising two components in the form of a powdery separation agent and a powdery anti-corrosion agent.

Expediently, the separation agent consists of polymethylmethacrylat powder. This powder has a spherical particle configuration. The anti-corrosion agent consists of one or several acids preferably adipic acid and/or boric acid and/or one or several organic acids. The particles of such a powder material do not have a specific configuration.

The entire amount of powder to be applied is calculated such that during the formation of stacks no or only little powder material falls down. An accumulation of material of powder falling down during the formation of stacks would cause a wedge-shaped gap being formed between the successive flat glass elements 2 on their bottom ends and thus lead to a wedge-shaped fanning of the stack 2′, as shown in FIGS. 1 and 2 by broken lines. The two components forming the powder application may be applied jointly, but, in order to avoid a mutual dependence of the partial quantities to be applied, have to be held ready independently from each and dosed independently from each. The application process, as shown in the example illustrated, may be carried out by spraying the powdery material on the upper side of the flat glass elements 2 lying on the transport line 1. In this example, the application device may comprise one or several application beams 5 expediently furnished with application nozzles 4 designed as spray nozzles, such beams 5 extending transversally to the direction of movement of the flat glass elements 2 transported below the said nozzles and having at least a length corresponding to the width of the flat glass elements 2. The application nozzles 4 are evenly distributed along the length of the associated application beam 5.

In the embodiment according to FIG. 1 provision is made for two application beams 5 arranged one behind the other at a small distance in the direction of the flat glass elements, such application beams 5 being expediently provided with application nozzles 4 on their mutually facing sides. Each one of the two application beams 5 of the embodiment according to FIG. 1 is associated with only one component of the powder application to be produced, i.e. associated either with the separation agent or only with the anti-corrosion agent. The application nozzles 4 of the two application beams 5 are simultaneously activated and/or passivated at a short interval, so that both components of the powder to be produced are practically applied simultaneously while being blended together. In the embodiment according to FIG. 2 only one such a nozzle beam 5 is provided which is supplied with a previously made blend of both components of the powder to be produced and whose application nozzles 4 already spray a blend of both components on the facing surface of the flat glass elements 2. In order to control the application beams 5 and/or their application nozzles 4, provision may be made for a sensor device 6 controlling the utilization of the transport line 1, for example in the form of a light barrier. It would, however, be equally conceivable to provide control in the tact of the production line.

A supply station 9 is arranged prior to the application device formed in the example illustrated by one or several application beams 5, in which the two components of the powder application to be applied on the flat glass elements 2 are held ready and dosed. The supply station 9 in both embodiments according to FIGS. 1 and 2 comprises a container arrangement with two containers 10a, 10b arranged adjacent to each other, in this example expediently funnel-shaped, which are designed and arranged for an associated component of the powder application to be applied on the flat glass elements 2. Correspondingly, one of the two containers, in this example the container 10a depicted on the left hand side is designed and arranged for the provision of the powdery separation agent, and the other container 10b is designed and arranged for the provision of the powdery anti-corrosion agent. The container 10a correspondingly contains the powdery separation agent and is provided with a supply chute 11a which may be connected with a supply device for powdery separation agent not shown in detail and through which the powdery separation agent can be filled in the associated container 10a. The container 10b contains the powdery anti-corrosion agent and can be filled with the powdery anti-corrosion agent via its supply chute 11a connected with a supply device for powdery anti-corrosion agent. Each of the both containers 10a,b can be provided with a suitable coating adapted to the property of the respective associated agent. The same practically can be made also at the both chutes 11a, 11b.

A dosing station is arranged subsequently to the container arrangement formed by the two containers 10a, b, such dosing station comprising two dosers 12, with a doser 12 each arranged at the exit of each one of the two containers 10a, b. The throughput volume of the two dosers 12 are adjustable independently from each other. The dosers 12 may comprise a dosing wheel each releasing a defined amount of powder upon each revolution. By setting the speed of rotation of the dosing wheel the desirable throughput volume and thus the partial quantity associated with each powdery component of the powder application to be applied on the flat glass elements 2 can thus be adjusted. The amount of powder released by the dosers 12 will be fed to the application device associated with the transport line 1.

In order to assure reliable transport of the powdery material to the application device, released by the dosers 12, an injector 13 is arranged subsequently to each doser 12. The injector 13 may simply be designed as a venturi nozzle whose main pipe is connected with an air pressure source generating an air jet and in whose side inlet the exit of each associated doser 12 exits.

As air pressure source generating the desirable air jet, provision is made for a compressor or fan 14 existing in the supply station 9, as can be seen in the FIGS. 1 and 2, which is connected with the two injectors 13 via a correspondingly branched air pressure line 15. The exit of the injectors 13 is connected with a flow line 16 each supplied with powder material coming from each associated container 10a, b, dosed by the associated doser 12 and fluidisized in the associated injector 13. The powder material fed to the flow lines is distributed to the application nozzles 4 of the application device subsequently arranged. For this purpose, provision is made for a suitable distribution device comprising an associated distributor 17 each for each application beam 5 of the application device.

In the embodiment according to FIG. 1 the application device comprises two application beams 5, each of which being associated with only one component of the powder application to be applied on the flat glass elements 2 and correspondingly supplied alternatively with only separation agent and/or only anti-corrosion agent. In this embodiment a separate distributor 17 is arranged prior to each application beam 5, such distributor 17 being connected with the container 10 provided for each associated component of the powder application via a branchless flow line 16 and the injector 13 and doser 12 arranged prior to the said flow line 16.

In the embodiment according to FIG. 2 the application device comprises only one application beam 5. Correspondingly, the distribution device comprises only one distributor 17 associated with the application beam 5. The distributor 17 is connected with a collection connecting piece 18 in which both flow lines 16 exit which are supplied from each associated container 10a, b via the injector 13 and the doser 12 arranged prior to the flow lines 16. Here, correspondingly, the powder components coming from the two containers 10a, b are already blended in the collection connecting piece 18 and/or distributor 17, whereas in the embodiment according to FIG. 1 the blending takes place only on or near the surface of the flat glass elements 2. In all other aspects, however, the embodiments according to FIGS. 1 and 2 are conform.

Each of the distributors 17 may comprise a cylinder-shaped housing in which each associated flow line 16 and/or the collection connecting pieces 18 exit from above, and in which a distribution cone is provided below the inlet, whereby in the region of the bottom circumference of the collection connecting piece provision is made for outlets 19 being evenly distributed on its circumference which are connected with an associated application nozzle 4 each via connection lines 20 illustrated only schematically in FIGS. 1 and 2. Each exit 19 of each distributor 17 may be associated with a shut off valve by which the application density and in particular the application width are controllable.

Irrespective of where the powdery separation agent is blended with the powdery anti-corrosion agent, both embodiments according to FIGS. 1 and 2 ensure that the partial quantities of the powdery separation agent and the powdery anti-corrosion agent applied on the flat glass elements 2 can be dosed independently from each other and thus according to demand, so that an excess of separation agent as well as a shortage of anti-corrosion agent is avoidable and vice versa.

As a variant to spraying the powder application according to the examples described above it would be conceivable to sprinkle on the powder application. In such a case, instead of application beams for forming the application device, provision may be made for dosing rollers extending across the width of the transport line 1 limiting an application gap together with associated gap limits. In this example, dosers associated with the powdery separation agent and the powdery anti-corrosion agent, provided with dosing rollers as described above may be integrated in the application device, thus simultaneously forming an element of the application device.

It is understood that the foregoing description is that of the exemplary embodiments of the disclosure and that various changes and modifications may be made thereto without departing from the spirit and scope of the disclosure as defined in the appended claims.

What is claimed is:

1. A method of providing flat glass elements with a corrosion protection and separation agent application containing a powdery anti-corrosion agent and a powdery separation agent, whereby the anti-corrosion agent and the separation agent are jointly applied on at least one side of the flat glass elements, wherein the anti-corrosion agent and the separation agent are held ready independently from each other and dosed independently from each other and are blended together after dosing.

2. The method in accordance with claim 1, wherein after dosage the anti-corrosion agent and the separation agent are fed separately to the elements of the application devices adjacent to each other and simultaneously activatable, and are blended together only when applied to the flat glass elements.

3. The method in accordance with claim 1, wherein the anti-corrosion agent and the separation agent are merged after dosage and are subsequently applied as a powder mixture to the flat glass elements by means of a common application device.

4. A device for carrying out the method in accordance with claim 1, the device comprising a dosing device, a container arrangement arranged upstream thereof, and further an application device arranged downstream thereof or acting together therewith, with flat glass elements being provided with a powdery corrosion protection and separation agent application containing a powdery anti-corrosion agent and a powdery separation agent by means of the application device, whereby the anti-corrosion agent and the separation agent are jointly applied on at least one side of the flat glass elements, and whereby the anti-corrosion agent and the separation agent are held ready independently from each other and dosed independently from each other and are blended together after dosing, characterized in that the container arrangement comprises a container associated with the anti-corrosion agent and a further container associated only with the powdery separation agent, with the one container being designed and arranged only for the provision of the powdery anti-corrosion agent and being suppliable therewith by a supply chute and with the further container being designed and arranged only for the provision of the powdery separation agent and being suppliable therewith by a supply chute, and further that the dosing device comprises two dosers, with an associated, separate doser being connected with the outlet of each container of the container arrangement, whereby the conveying quantity of the doser associated with the anticorrosion agent is adjustable independently from the conveying quantity of the doser associated with the separation agent and whereby each doser is connected on its outlet with the application device or forms an element of the application device.

5. The device in accordance with claim 4, wherein each doser issues in an associated injector which is suppliable with an air jet and connected with a flow line leading to the application device.

6. The device in accordance with claim 4, wherein the application device comprises at least one application beam arranged transversely to the direction of feed of the flat glass elements transportable below the said application device comprising several application nozzles distributed along its length, with each application beam being connected with a distributor arranged downstream of the dosing device, which comprises several outlets connected with the application nozzles of the associated application beam and further comprises an inlet which is connected with at least one flow line branching off the dosing device.

7. The device in accordance with claim 6, wherein the application device comprises two mutually adjacent applications beams and that for each application beam an associated distributor is provided whose inlet is connected with a branchless flow line suppliable only from one associated container of the container arrangement.

8. The device in accordance with claim 6, wherein the application beam comprises only one application beam and that the distributor associated therewith is connected on the inlet side with a collection connecting piece in which issue the flow lines suppliable from both containers of the container arrangement.

9. The device in accordance with claim 4, wherein each doser of the dosing device comprises a dosing wheel releasing a defined amount of powder upon each revolution and whose speed of rotation is adjustable depending on the desirable amount of application of the associated component of the entire powder application.

10. The device in accordance with claim 4, wherein each distributor comprises several outlets, each of them connected with an application nozzle, and associated with a shut off valve, and that each distributor comprises a distribution cone arranged below the inlet thereof, whereby in the region of the bottom circumference of the distribution cone provision is made for the outlets evenly distributed thereon and the shut off valves associated with the latter.

11. The device in accordance with claim 4, wherein each injector is designed as a venturi nozzle connected with an air jet source and comprises a side inlet connected with a doser associated with each container of the container arrangement.

12. The device in accordance with claim 4, wherein the flat glass elements are transportable on a horizontal conveying device leading to a stack rack, to which horizontal conveying device a sensor is associated monitoring its utilization by which the application nozzles of each application beam are controllable.
